(19) United States
(12) Patent Application Publication
(10) Pub. No.: US 2018/0188672 A1
(43) Pub. Date: Jul. 5, 2018

(54) IMAGE HEATING APPARATUS

(71) Applicant: CANON KABUSHIKI KAISHA, Tokyo (JP)

(72) Inventor: Hiroki Kawai, Abiko-shi (JP)

(21) Appl. No.: 15/905,154

(22) Filed: Feb. 26, 2018

Related U.S. Application Data
(63) Continuation of application No. PCT/JP2016/075736, filed on Aug. 26, 2016.

(30) Foreign Application Priority Data
Aug. 27, 2015 (JP) 2015-167620

(51) Int. Cl. G03G 15/20

(52) U.S. Cl. CPC G03G 15/205; G03G 15/2089; G03G 2215/2041; G03G 15/2078; G03G 15/55

(57) ABSTRACT

An image heating apparatus includes an endless belt for heating a toner image on a sheet; a first detector for detecting a temperature of one longitudinal end portion of the endless belt; a second detector for detecting a temperature of the other longitudinal end portion of the endless belt; and a controller for controlling whether or not notification of generation of an error is provided on the basis of a change amount per unit time of a difference in detection temperature between the first detector and the second detector.

### TECHNICAL FIELD

The present invention relates to an image heating apparatus for heating a toner image on a recording material.

Conventionally, in the image forming apparatus of an electrophotographic type, a toner image formed on a recording material (sheet) is heated and pressed and thus fixed by a fixing device (image heating apparatus).

Then, in recent years, from viewpoints of a quick start property and an energy saving property, a fixing using a fixing belt (film) thin and small in thermal capacity has been put into practical use.

In such a fixing device using the thin fixing belt, there is a liability that a crack generates at a longitudinal end portion of the fixing belt. For example, there is a rare case such that the recording material fastened with a staple is introduced into the fixing device and the fixing belt is damaged and thus the crack generates. Even in such a rare case, it has been required that the crack of the fixing belt can be detected quickly.

Therefore, a technique in which a thermistor for detecting one longitudinal end portion of the fixing belt is provided and when a detection temperature of the thermistor is below a predetermined temperature, abnormality of the fixing device is detected has been proposed (Japanese Laid-Open Patent Application (JP-A) 2010-134035).

Further, a technique in which thermistors for detecting temperatures at one longitudinal end portion and the other longitudinal end portion, respectively, of a fixing belt and when a temperature difference therebetween is a predetermined temperature difference is a predetermined temperature difference set in advance, discrimination that breakage of the fixing belt generated is made has been proposed (JP-A 2014-16411).

However, in a method proposed in JP-A 2010-134035, when the crack generated in the fixing belt, it takes a time until the detection temperature by the thermistor lowers to the predetermined temperature, and therefore, it becomes difficult to detect the temperature early.

Further, in a method proposed in JP-A 2014-16411, there is a liability that in the case where an introducing position of the recording material shifts from a reference position toward one longitudinal end side of the fixing belt, erroneous detection is made. This is because even in the case where the crack does not generate in the fixing belt, a detection temperature difference between both the thermistors reaches a predetermined temperature difference and thus erroneous detection such that the crack generated in the fixing belt is made.

### SUMMARY OF THE INVENTION

According to an aspect of the present invention, there is provided an image heating apparatus comprising: an endless belt for heating a toner image on a sheet; a first detector for detecting a temperature of one longitudinal end portion of the endless belt; a second detector for detecting a temperature of the other longitudinal end portion of the endless belt; and a controller for controlling whether or not notification of generation of an error is provided on the basis of a change amount per unit time of a difference in detection temperature between the first detector and the second detector.

### BRIEF DESCRIPTION OF THE DRAWINGS

FIG. 1 is a sectional view of a fixing device.

FIG. 2 is a sectional view of an image forming apparatus in which the fixing device is mounted.

FIG. 3 is a sectional view of the fixing device.

FIG. 4 is a schematic view of the fixing device in the case where a crack generates.

FIG. 5 is a flowchart for detecting error generation.

FIG. 6 is a schematic view showing an operating portion for providing notification of abnormality.

FIG. 7 is a graph showing a change of a detection temperature of a thermistor.

FIG. 8 is a graph showing a changes of a detection temperature during passing of a sheet shifted toward one (longitudinal) end.

### EMBODIMENT FOR CARRYING OUT THE INVENTION

Preferred embodiments of the present invention will be described below using the drawings.

### First Embodiment

### Image forming Apparatus

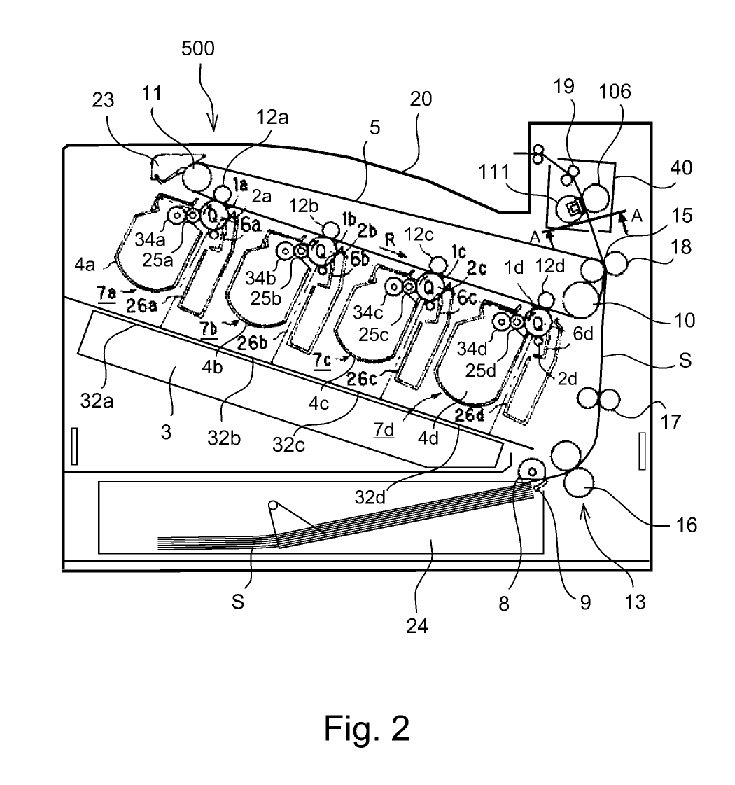

FIG. 2 is a sectional view of an image forming apparatus 500 in which a fixing device is mounted. Four cartridges 7 (7a-7d) which are juxtaposed obliquely with respect to an up-down direction include photosensitive drum units 26 (26a-26d) including photosensitive drums 1 (1a-1d) as electrophotographic photosensitive members and include developing units 4 (4a-4d).

The photosensitive drums 1 are rotationally driven clockwisely (in Q direction) in FIG. 2 by a driving member (not shown). At peripheries of the photosensitive drums 1, in the order of a rotational direction thereof, cleaning members 6 (6a-6d), charging rollers 2 (2a-2d) and the developing units 4. The cleaning members 6 remove toner agents remaining on the photosensitive drums 1 after the toner images are transferred from the photosensitive drums 1 onto an intermediary transfer belt 5. The toner agents removed by the cleaning members 6 are collected in toner chambers in photosensitive member units 26 (26a-26d).

The charging rollers 2 electrically charge surfaces of the photosensitive drums 1 uniformly. After the surfaces of the photosensitive drums 1 are charged by the charging rollers 2, the surfaces of the photosensitive drums 1 are exposed to laser light from a scanner unit (exposure means) 3 through unit openings 32 (32a-32d). As a result, electrostatic latent images are formed on the surfaces of the photosensitive drums 1. In this embodiment, the scanner unit 3 is disposed below the cartridge 7.

The developing units 4 supply the toner agents to the electrostatic latent images formed on the photosensitive drums 1 and develop the electrostatic latent images into the toner images. The developing units 4 include developing rollers 25 (25a-25d) for supplying the toner agents to the surfaces of the photosensitive drums 1 in contact with the photosensitive drums 1 and supplying rollers 34 (34a-34d) for supplying the toner agents to the surfaces of the developing rollers 25 in contact with the developing rollers 25.

When the image is formed on a recording material S, first, the electrostatic latent images formed on the surfaces of the photosensitive drums 1 by the scanner unit 3 are developed into the toner images by the cartridges 7 and then are transferred onto the intermediary transfer belt 5.

The intermediary transfer belt 5 is stretched by a driving roller 10 and a tension roller 11 and is driven in an arrow R direction in FIG. 2. Inside the intermediary transfer belt 5, primary transfer rollers 12 (12a-12d) are provided opposed to the photosensitive drums 1, and to the primary transfer rollers 12, transfer biases are applied by unshown bias applying means. For example, in the case where negatively charged toner agents are used, by applying positive biases to the primary transfer rollers 12, the toner images are successively transferred onto the intermediary transfer belt 5.

Then, the four color toner images are fed to a secondary transfer portion 15 in a state in which four color toner images are superposed on the intermediary transfer belt 5. At this time, the toner agents remaining on the intermediary transfer belt 5 after the secondary transfer onto the recording material S are removed by a transfer belt cleaning device 23, and the removed toner agents pass through a residual (waste) toner feeding path (not shown) and are collected by a residual (waste) toner collecting container (not shown).

On the other hand, in synchronism with an image forming operation described above, the recording material S is fed toward the secondary transfer portion 15 by a feeding mechanism including a feeding device 13, a registration roller pair 17 and the like. The feeding device 13 includes a feeding cassette 24 for accommodating a plurality of recording materials S, a feeding roller 8 and a feeding roller pair 16 for feeding the fed recording material S.

The feeding cassette 24 is detachably mountable to the image forming 1. A user pulls out the feeding cassette 24 and is demounted from the image forming apparatus 1, and then sets the recording materials S in the feeding cassette 24 and inserts the feeding cassette 24 into the image forming apparatus 1, so that supply of the recording materials S is completed.

Of the recording materials S accommodated in the feeding cassette 24, the recording material S located in an uppermost portion is separated one by one by press-contact of the feeding roller 8 and a separation pad 9 with rotation of the feeding roller 8 (friction separation type), and then is fed. The recording material S fed from the feeding device 13 is fed to the secondary transfer portion 15 by the registration roller pair 17. At the secondary transfer portion 15, by applying a positive bias to a secondary transfer roller 18, it is possible to secondary-transfer the four color toner images from the intermediary transfer belt 5 onto the fed recording material S.

Then, the recording material (sheet) S is fed from the secondary transfer portion 15 to a fixing device 40 as an image heating apparatus, in which heat and pressure are applied to the images transferred on the recording material S, so that the images are fixed on the recording material S. Thereafter, the recording material S on which the toner images are fixed is discharged onto a discharge tray 20 by a discharging roller pair 19.

### Image Heating Apparatus

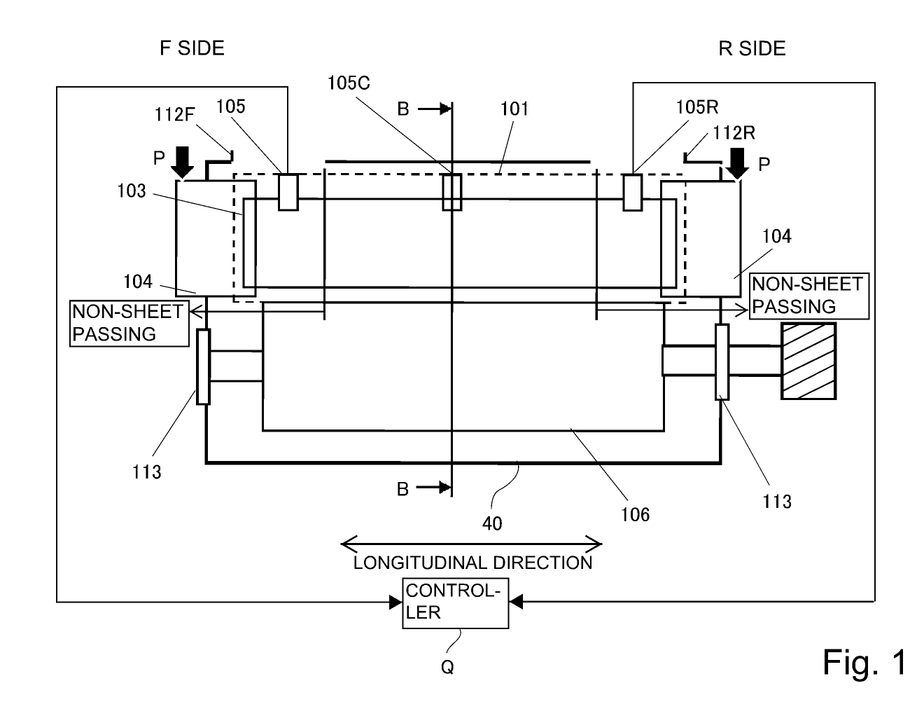

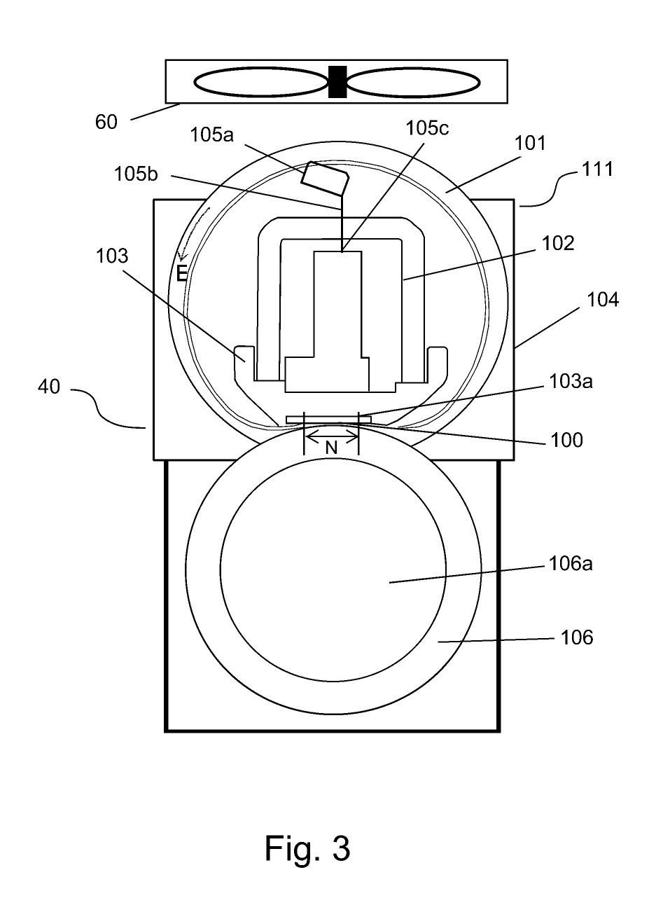

Next, a structure of the fixing device 40 as the image heating apparatus in this embodiment will be described. The fixing device 40 includes a fixing belt (hereinafter, also referred to as a fixing film). A sectional view (A-A sectional view of FIG. 2) of the fixing device 40 in this embodiment is shown in FIG. 1, and a sectional view (B-B sectional view of FIG. 1) of the fixing device 40 is shown in FIG. 3.

In FIG. 3, the fixing device 40 includes a pressing roller 106 as a pressing member (rotatable member), a ceramic heater 100 as a plate-shaped heater, and the fixing film 101. Further, the fixing device 40 includes fixing flanges (preventing portions) 104, provided at both longitudinal end portions of the fixing film, for preventing movement of the fixing film in a longitudinal direction, and includes a press-contact member 103 for forming a nip N between itself and the pressing roller 106 sandwiching the fixing film 101 therebetween. Further, the fixing device 40 includes a stay 102 provided on an inner surface side of the fixing film in order to ensure strength of the press-contact member 103.

### Film Unit

Here, an assembly of this fixing film 101, the ceramic heater (hereinafter, referred to as a heater) 100, the press-contact member 103, the stay 102, thermistors 105 and the fixing flanges 104 is a film unit 111.

### 1) Fixing Film

The fixing film 101 is a cylindrical heat-resistant fixing film as a heat-generating member for conducting heat to the recording material P and is loosely fitted around the press-contact member 103. The fixing film 101 may desirably have a fixing thickness of 100 μm or less, preferably 50 μm or less and 20 μm or more and have a heat-resistant property in order to improve a quick start property by decreasing thermal capacity. Specifically, a single layer film of PEEK, PES or FEP or a composite layer film in which an outer peripheral surface of polyimide, polyamideimide, PEEK, PES, PPS or the like is coated with PTFE, PFA, FEP or the like can be used. Further, a film made of metal can also be used.

### 2) Heater

100 is the heater as a heating means. this heater 100 has a basic structure including an elongated thin plate-like ceramic substrate and an energization heat generation resistor layer formed on a surface of the substrate, and is low thermal capacity heater which increases in temperature with an abrupt temperature rise characteristic as a whole by energization to the heat generation resistor layer. This heater 100 is engaged in and supported by an engaging groove 103a provided on a lower surface of the press-contact member 103 along the longitudinal direction of the press-contact member 103.

### 3) Press-Contact Member

The press-contact member 103 is a heat-resistant and heat-insulating member of which direction crossing a recording material feeding direction is a longitudinal direction and which has a substantially arcuate (semi-circular) shape in cross-section. The press-contact member 103 performs functions of back-up of the fixing film 101, pressure application to the nip N formed by the press-contact of the pressing roller 106 with the fixing film 101, and feeding stability of the fixing film 101 during rotation of the fixing film 101. Further, as a material of the press-contact member 103, a material having good insulating and heat-resistant properties, such as phenolic resin, polyimide resin, polyamide resin, polyamideimide resin, PEEK resin, PES resin, PPS resin, PFA resin, PTFE resin, LCP resin or the like is used.

### 4) Stay

The stay 102 is a member for imparting longitudinal strength to the press-contact member 103 and for rectifying the press-contact member 103 by being pressed against a back surface of the press-contact member 103 made of a relatively soft resin.

### 5) Thermistor

The thermistor 105 as a detector detects, on an inside of the fixing belt, a temperature of the fixing belt (film) at a predetermined position with respect to a widthwise direction (longitudinal direction) of the fixing belt, and detects a fixing film inner surface temperature and then feeds back the temperature to a controller Q (FIG. 1). The thermistor 105 includes a temperature detecting element portion 105a for detecting the temperature in contact with a fixing film inner surface and includes a leaf spring portion 105b, having elasticity, for being urged against the fixing film with predetermined contact pressure. Further, the thermistor 105 includes a holding portion 105c for being fixedly mounted and held by the press-contact member 103. This leaf spring portion 105b is made of stainless steel and also constitutes an electroconductive path of the temperature detecting element portion 105a.

### 6] Fixing Flange

The fixing flanges (preventing portions) 104 shown in FIG. 3 and FIG. 1 are engaged with both ends of an assembly of the press-contact member 103 and the stay 102, and not only guides rotation of the fixing film 101 but also prevents slip-out of the fixing film 101. In Embodiment 1, to the fixing flanges 104 disposed at both ends of the fixing film 101, pressure (pressing force) is applied by pressing plates (not shown) rotatably attached to fixing frames 112, so that the film unit 111 and the pressing roller 106 are pressed in an arrow P direction of FIG. 1.

### Pressing Member

In FIG. 3, the pressing roller 106 as a pressing member (rotatable member) is rotationally driven by transmitting drive thereto by an unshown fixing motor mounted in the image forming apparatus 500, so that the fixing film 101 is driven by the pressing roller 106 and thus is rotated in an arrow E direction of FIG. 3.

The pressing roller 106 is constituted by a core metal 106a made of metal and a heat-resistant elastic material layer which is molded and coated in a roller shape around the core metal so as to be concentrically integral with the core metal and which is made of a silicone rubber, a fluorine-containing rubber, a fluorine-containing resin or the like, and as a surface layer, a parting layer is provided. For example, as a material of the parting layer, it is possible to select a material having good parting property and heat-resistant property, such as fluorine-containing resin, silicone resin, fluoro-silicone rubber, fluorine-containing rubber, silicone rubber, PFA, PTFE, FEP or the like.

At both end portions of the core metal 106a, bearing members 113 (FIG. 1) made of a heat-resistant resin such as PEEK, PPS, liquid crystal polymer or the like is mounted, and are rotatably held by and provided on side plates of the fixing frames 112.

### Thermistor Arrangement

In this embodiment, three thermistors 105 are disposed along the longitudinal direction of the fixing film 101 shown by a broken line in FIG. 1, and a longitudinal F side is 105F, a central side is 105C, and a longitudinal R side is 105R. The thermistor 105C is a thermistor having a function of controlling temperature (temperature control) of the fixing device 40 and controls energization to the heater 100 by a detection temperature. The thermistor 105F and the thermistor 105R are disposed symmetrically at longitudinal end sides of the fixing film 101 with respect to a longitudinal central portion. Specifically, the thermistor 105F and the thermistor 105R are symmetrically disposed at positions of 153 mm from the central portion with respect to the longitudinal direction, respectively.

In the case where sheet feeding is carried out on a center (line) basis, when a maximum-sized sheet is passed through the fixing nip N, if the sheet passes through a central reference position, detection temperatures of the end portion thermistors are both maintained at a certain temperature (170° C.) Further, if the sheet passes through a shifted position, only the detection temperature of one of the thermistors gradually increases.

### Crack Detection Control Constitution

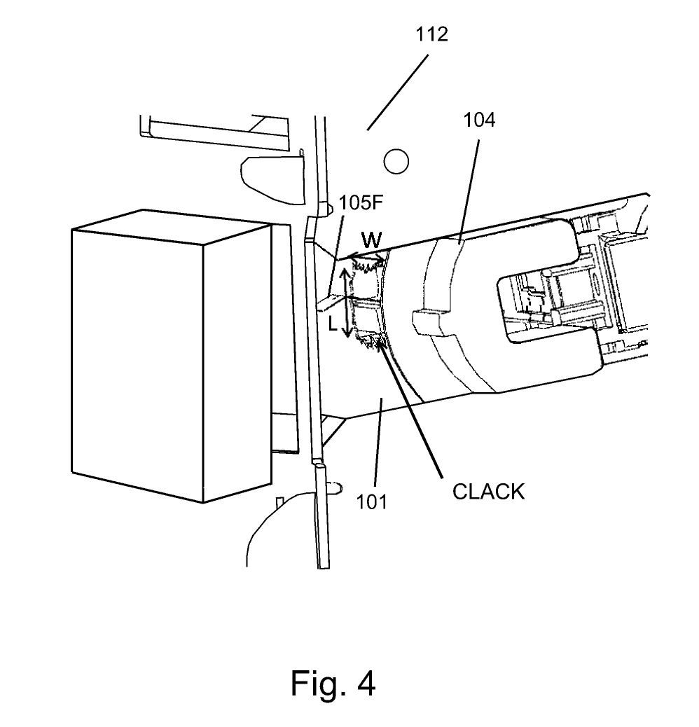

Next, a control constitution in which in the case where the crack generated in the fixing film 101 during sheet passing of the fixing device 40 in this embodiment crack generation is detected in association with the detection temperatures of the thermistors 105F and 105R will be described. In this embodiment, the case where the sheet feeding was carried out on the center basis and the crack generated only at the F side end portion of the fixing film 101 as shown in FIG. 4 will be described as an example. A crack length with respect to the longitudinal direction of the fixing film is W and a crack length with respect to a circumferential direction of the fixing film is L.

The case where during the passing of the sheet (A4 size of 105 gsm in this embodiment), the crack generates in the fixing film 101 and the crack length W with respect to the longitudinal direction reaches the position of the thermistor 105F will be described. Then, the thermistor 105F causes improper contact with the inner surface of the fixing film 101 or is exposed from the fixing film, with the result that the detection temperature of the thermistor 105F abruptly lowers.

On the other hand, the thermistor 105R provided at a longitudinal symmetrical position with the thermistor 105F continuously detects the temperature of the fixing film inner surface temperature-controlled constantly by temperature control, and therefore the detection temperature is maintained at a substantially constant temperature (about 190° C. in this embodiment).

At this time, a temperature difference between the thermistor 105F and the thermistor 105R increases. Further, in this embodiment, in the case where a time change rate of an increase of this temperature difference is larger than a predetermined value, the crack is detected. The reason why the crack is detected by the time change rate of the temperature difference is that this is excellent from viewpoints of immediacy of the detection and prevention of erroneous detection, and this will be specifically described later.

As regards the contents of specific detection control, the temperature difference between the thermistor 105F and the thermistor 105R is ΔT and a fluctuation (increase or decrease) of ΔT per (one) second is ΔT/s, and when ΔT/s>10° C. is satisfied, discrimination that the crack occurs is made.

### Detection Control Flowchart

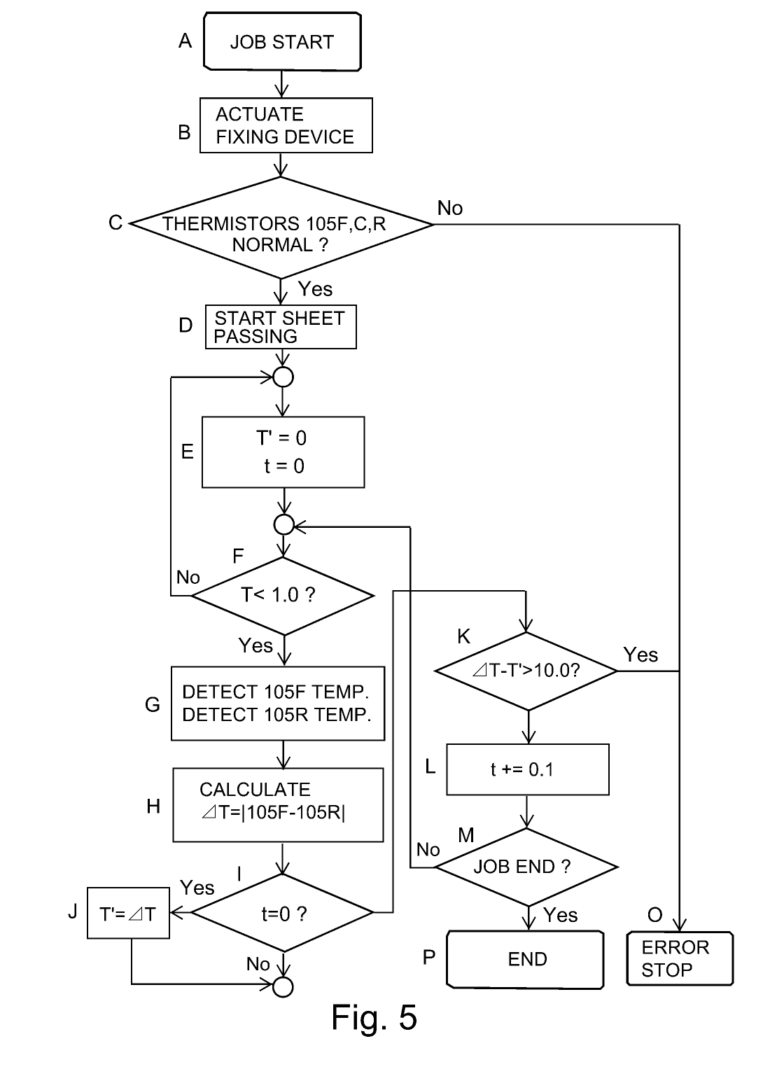

Next, control of detecting the crack generation of the fixing film 101 in this embodiment will be described using a flowchart of FIG. 5. Incidentally, control other than that of the fixing device 40 in this embodiment will be omitted in this embodiment.

In FIG. 5, first, a job starts (A). Then, energization to the heater 100 of the fixing device 40 is carried out, and the fixing motor is rotated, so that rising (actuation) of the fixing device 40 is carried out (B). Next, whether or not the thermistors 105F, C, R normally operate is checked (C). In the case where if the thermistors 105F, C, R do not normally operate, the fixing device 40 or the thermistors 105F, C, R cause abnormality, and therefore, the image forming apparatus is stopped (shut down) (O). In the case where the thermistors 105F, C, R normally operate, sheet passing through the fixing device 40 is started (D).

Here, as regards the control of detecting the crack generation of the fixing film 101 in this embodiment, discrimination of occurrence or non-occurrence of the crack (crack generation) is carried out per (one) second (data acquisition of the differential temperature ΔT is carried out per 0.1 second, and therefore, data acquisition of 10 times is carried out per second in which the discrimination is carried out).

In FIG. 5, in the case where the sheet passing is started, an initial differential temperature variable, between the thermistor 105F and the thermistor 105R, which is a reference value of discrimination of 1-sec crack generation (discrimination of the occurrence or non-occurrence of the crack for 1 second) is defined as T′, and an initial value of 0 is assigned to T′. Further, an elapsed time counter (value) is defined as t, and an initial value of 0 is assigned to t (E). Here, in the case where the elapsed time exceeds 1 second, the sequence goes to (E), and in the case where the elapsed time is less than 1 second, the sequence goes to (G) (F).

Then, every 0.1 second, the detection temperatures of the thermistors 105F and 105R at that time are recorded, respectively (G). Further, an absolute value of a difference between the respective temperatures detected in (G) is calculated and is assigned to the differential temperature ΔT (H). Only in the case where detection timing is initial timing (t=0), ΔT calculated in (H) is assigned to T′. This T′ is a reference value for making comparison as to whether ΔT is increased or decreased to what extent for 1 second. In 1-second detection loop other than initial 1-second detection loop, the value of T′ is not renewed and is a fixed value (ΔT calculated in (H)), and the sequence goes to subsequent steps (I) (J).

Then, as discrimination of the 1-second crack generation (discrimination of the occurrence or non-occurrence of the crack for 1 second), whether or not ΔT exceeds T′ by more than 10° C. is discriminated (K). In the case where if ΔT exceeds T′ by more than 10° C. (in the case where any of values of the differential temperature ΔT of 10 times subjected to the data acquisition for 1 second falls under this condition), discrimination that the crack generated in the fixing film 101 in 1 second is made, and the image forming apparatus is immediately stopped (O).

On the other hand, in the case where ΔT does not exceed T′ by 10° C. or more (in the case where any of values of the differential temperature ΔT of 10 times subjected to the data acquisition for 1 second does not fall under this condition), discrimination that the crack does not generate in the fixing film 101 in 1 second is made. Then, the elapsed time counter t is incremented by 0.1 sec (whereby one new data of the differential temperature ΔT is added) and the sequence goes to a subsequent step (L). Then, the steps E to L are repeated until the sheet passing ends (M).

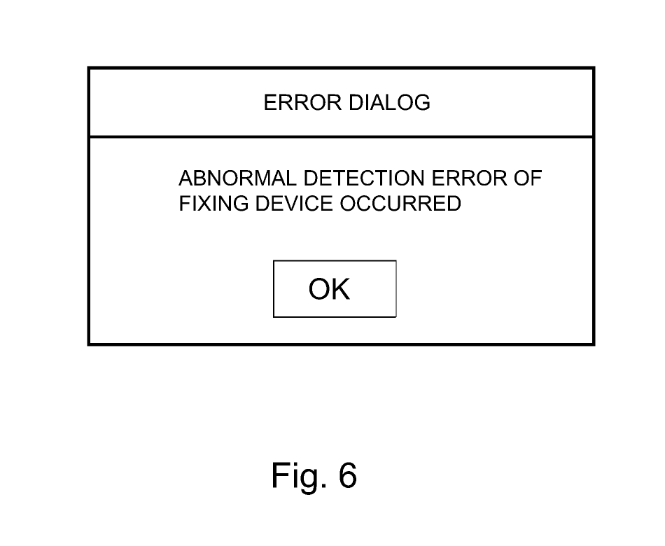

Here, in the case where the sequence leads to the step (O) in which the image forming apparatus stops, display as shown in FIG. 6 is made on a panel (not shown) mounted on the image forming apparatus or on a monitor (not shown) connected with the image forming apparatus, so that a user is notified of abnormality of the image forming apparatus. That is, in the step (K), in the case where ΔT exceeds T′ by 10° C. or more, discrimination that the crack generated in the fixing film is made, and the user is notified of warning.

### Thermistor Detection Temperature Change in Detection Control in This Embodiment

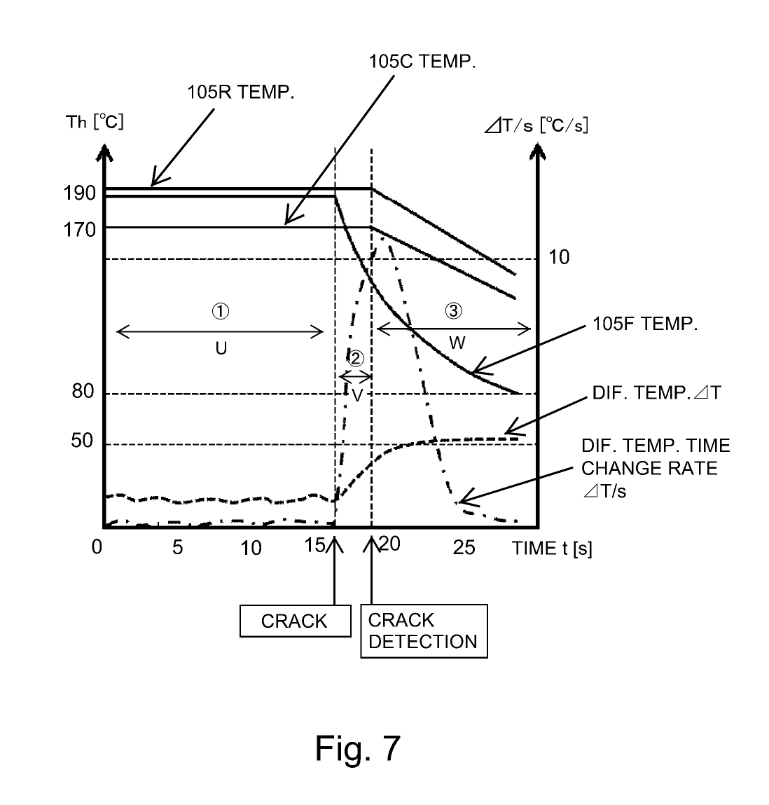

In this embodiment, the detection temperatures of the thermistors from the generation of the crack during the sheet passing until the abnormality of the fixing film 101 is detected will be described using states of U, V and W in FIG. 7. FIG. 7 is a graph showing the detection temperatures of the thermistors 105F, 105R and 105C, the detection temperature difference ΔT between the thermistors 105F and 105R, and the time change rate ΔT/s of ΔT. The abscissa represents a time t [s], a first ordinate (left side of FIG. 7) represents detection temperatures Th [° C.] of the thermistors 105F, 105R and 105C and of ΔT, and a second ordinate (right side of FIG. 7) represents a detection temperature [° C.] of the time change rate ΔT/s of ΔT.

First, U will be described. U represents a state in which the crack does not generate in the fixing film 101 and shows a state that the fixing device 40 is during the sheet passing. The detection temperature of the thermistor 105C progresses in the neighborhood of 170° C. which is a control temperature, and the detection temperatures of the thermistors 105F and 105R progress in the neighborhood of 190° C. Further, the detection temperature difference of ΔT in this state is within 5° C., and ΔT/s is within 1° C./s.

Next, V will be described. V shows a state, changed from the state of U, in which the crack generated in the fixing film 101 during the sheet passing. The detection temperature of the thermistor 105F abruptly lowers and ΔT and ΔT/s abruptly increases. Finally, W will be described. At timing when ΔT/s exceeds 10° C./s from the state of V, notification that the fixing film 101 is in a state in which the crack generated is provided, and the image forming apparatus is stopped.

### Effectiveness Test of Detection Control in This Embodiment

As timing of conventional control of detecting fixing device abnormality during the sheet passing, timing when the detection temperature of the thermistor is an abnormal low temperature (about 80° C. in this embodiment) during the temperature control (corresponding to U of FIG. 7) exists. Further, it is possible to cite the case where the detection temperature difference (differential temperature difference ΔT) of the thermistors abnormally increases (the differential temperature ΔT shown in FIG. 7 is about 50° C., for example). A comparison between such conventional control and control (the differential temperature time change rate ΔT/s of FIG. 7) in this embodiment was checked in the following items.

### (1) Immediacy of Detection

Continuation of the operation in the state in which the crack generated in the fixing film involves generation of various harmful influences, and therefore, it is desirable that the apparatus is stopped immediately after the detection (of the crack). From this viewpoint, a comparison of effectiveness in the above-described three controls was made. When the respective temperature changes after the crack generation shown in FIG. 7 are checked, quickest detection of the crack is about 3 seconds in the control in this embodiment, and subsequent detection of the crack is about 7 seconds in the conventional control in which arrival of the differential temperature difference ΔT at 50° C. is detected. Further, slowest detection of the crack is made in the conventional control in which detection that the detection temperature of the thermistor 105F is below 80° C. is made, so that it was confirmed that it takes a long time compared with the above-described two controls.

### (2) Preventing Property of Erroneous Detection

Next, a comparison test of an erroneous detection property in the following situation was conducted between the conventional control in which the differential temperature of the respective thermistors is used as it is and the control of this embodiment in which the time change rate of the differential temperature of the respective thermistors is used. In this comparison test, in a continuous sheet passing job, with respect to the fixing film longitudinal direction, the recording material (recording paper) was shifted to one side and was subjected to sheet passing (one side-shifted sheet passing). Incidentally, the sheet used in this embodiment is an A4-sized sheet of 105 gsm.

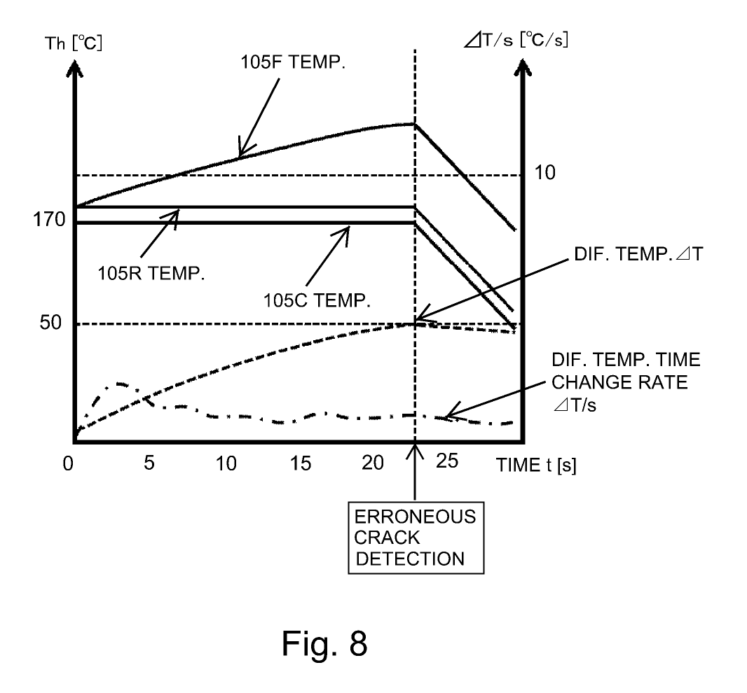

FIG. 8 is a graph showing respective changes of the detection temperatures of the thermistors 105F, 105R and 105C, the detection temperature difference ΔT of the thermistors 105F and 105R, and the time change rate ΔT/s of ΔT during the one side-shifted sheet passing.

When the recording material (recording paper) is passed through the fixing device, the recording material takes heat in a passing region (sheet-passing region) of the recording material (recording paper) in the fixing film but does not take heat in non-passing region (non-sheet-passing region) of the recording material, and therefore, the temperature in the non-sheet-passing region is higher than the temperature in the sheet-passing region (non-sheet-passing portion temperature rise). Here, in the case where the recording material (recording paper) is shifted toward the thermistor 105R side and is passed through the fixing device, a highest temperature portion by the non-sheet-passing portion temperature rise is asymmetrical with respect to the longitudinal direction, so that a difference generates in detection temperature between the thermistors 105F and 105R. The difference in detection between the thermistors 105F and 105R in FIG. 8 generates for this reason.

In the case where the detection temperature difference due to such one side-shifted sheet passing generates, in the conventional control in which the differential temperature between the respective thermistors is used as it is, also in the case where the crack does not generate in the fixing film, the differential temperature reaches 50° C. in some cases (FIG. 8). That is, in this case, erroneous detection that the crack generated in the fixing film is made. However, it was confirmed that such erroneous detection does not generate in the control of this embodiment using the time change rate of the differential temperature between the respective thermistors.

### (3) Total Detection Performance

From the above, when this embodiment using the fluctuation ΔT/s per 1 sec of the temperature difference ΔT between the thermistor 105F and the thermistor 105R is applied to the image forming apparatus 500, it was confirmed that the immediacy of the crack detection of the fixing film is excellent and also the erroneous detection preventing property is excellent.

### Effect of This Embodiment

When the fixing device to which this embodiment is applied is used, before the crack generated in the fixing film causes damage to another component part, it becomes possible to quickly detect the crack of the fixing film with no erroneous detection. For that reason, in the case where the crack generated in the fixing film, it can be met by exchanging only the fixing film or a component part (the pressing roller, for example) contacting the fixing film, so that it is possible to realize a reduction of downtime and improvement of reliability of the apparatus.

### Modified Embodiments

In the above-described embodiment, a preferred embodiment of the present invention was described, but the present invention is not limited thereto but can also be variously modified within the scope of thereof.

### Modified Embodiment 1

In the above-described embodiment, the case where the crack generated in the fixing film during the sheet passing and the crack length W with respect to the longitudinal direction reaches the position of the thermistor 105F was described, but similar detection can be made even when the crack length W does not reach the position of the thermistor 105F. That is, when the crack generates as shown in FIG. 7, the detection temperature of the thermistor 105F lowers more abruptly than the detection temperature of the thermistor 105R. Then, when the time change rate ΔT/s of the differential temperature ΔT exceeds 10° C., the crack detection can be made.

Incidentally, in the above-described embodiment, the case where the crack generated on the F side of the fixing film 101 was described as an example, but even in the case where the crack generated on the R side, the crack can be detected by the thermistor 105R similarly as in the case where the crack generated on the F side.

### Modified Embodiment 2

In the above-described embodiment, the temperature difference between the respective detection temperatures of the first and second temperature detecting members was calculated, and on the basis of the time change rate of the calculated temperature difference, the controller provided notification of abnormality (generation of the crack) of the fixing film, but the present invention is not limited thereto. On the basis of the time change rate of at least one of the respective detection temperatures of the first and second detecting members, the controller may also provide notification of abnormality (generation of the crack) of the fixing film.

Further, a single temperature detecting member, not the plurality of temperature detecting members such as the first and second temperature detecting members is provided, and on the basis of the time change rate of the detection temperature, the controller may also provide notification of abnormality (generation of the crack) of the fixing film. However, when the abnormality (generation of the crack) of the fixing film is notified on the basis of the time change rate of the detection temperatures of the plurality of temperature detecting members, the crack can be detected more quickly irrespective of a place where the crack generates and by using the time change rate of the differential temperature between the detection temperatures of the plurality of temperature detecting members, and thus the use of the plurality of temperature detecting members is preferable.

### Modified Embodiment 3

In the above-described embodiment, the control by the time change rate of the differential temperature between the thermistor 105F on one end portion side with respect to the widthwise direction and the thermistor 105R on the other end portion side with respect to the widthwise direction was shown, but the present invention is not limited thereto. For example, control by the time change rate of the differential temperature between the thermistor 105F (or the thermistor 105R) and the thermistor 105C at the central portion with respect to the widthwise direction may also be employed. Further, in a fixing device constitution in which a plurality of temperature detecting members move in the number than the temperature detecting members in this embodiment, even when a combination providing a pair such that at least one temperature detecting member is in the neighborhood of the non-sheet-passing portion is used, control by the time change rate of the differential temperature of the thermistor pair can be carried out.

### Modified Embodiment 4

The image heating apparatus according to the present invention includes the control providing notification of abnormality of the fixing film on the basis of the time change rate of the detection temperatures, and this controller is not limited to a controller (CPU provided in the image forming apparatus) carrying out both of control relating to the image formation and control relating to image heating (fixing). That is, the controller may also be a controller exclusively carrying out the control relating to the fixing.

Further, the image heating apparatus according to the present invention is not limited to one fixedly provided in the image forming apparatus, but may also be one which is assembled as a unit and which can be demounted to an outside of the image forming apparatus and then can be exchanged. In this case, the image heating apparatus may be demounted and exchanged inclusive of the controller and may also be demounted and exchanged exclusive of the controller. Further, the image heating apparatus according to the present invention may also be used alone as the image heating apparatus independently of the image forming apparatus.

### Modified Embodiment 5

In the above-described embodiment, the endless belt was provided on the first rotatable member was described, but the endless belt was provided on the second rotatable member. Further, the endless belt may also be provided on both of the first and second rotatable members.

Further, in the above-described embodiment, the case where of the rotatable pressing member as the rotatable member and as the pressing member pressed the rotatable fixing member was described. However, the present invention is not limited thereto, but is similarly applicable to also the case where the second rotatable member as an opposing member, not the pressing member is pressed by the fixing belt (film) as the rotatable fixing member. Here, the opposing member if a member, which opposes the rotatable fixing member and which forms a fixing nip in press-contact with the rotatable fixing member, for nipping a moving recording material at the fixing nip.

In the above-described embodiment, as the pressing member, the rotatable pressing roller member rotating together with the rotatable fixing member was used, but the present invention is not limited thereto, but may also be applicable to a flat plate-shaped pressing pad fixed as the pressing member.

Further, in the above-described embodiment, as the recording material, the recording paper was described, but the recording material in the present invention is not limited to the paper. In general, the recording material is a sheet-shaped member on which the toner image is formed by the image forming apparatus and includes, for example, regular or irregular members of plain paper, thick paper, thin paper, envelope, post-card, seal, resin sheet, OHP sheet, glossy paper and the like. In the above-described embodiment, for convenience, dealing of the recording material (sheet) P was described using terms, such as the sheet passing, the sheet passing portion, the non-sheet-passing portion, but by this, the recording material in the present invention is not limited to the paper.

Further, in the above-described embodiment, the fixing device for fixing the unfixed toner image on the sheet was described as an example, but the present invention is not limited thereto, and is also similarly applicable to an apparatus for heating and pressing a toner image, temporarily fixed on the sheet, in order to improve glossiness of the image.

### INDUSTRIAL APPLICABILITY

An image heating apparatus capable of properly detecting abnormality of the fixing belt (film) of the fixing device of the image forming apparatus is provided.

1. An image heating apparatus comprising:
an endless belt for heating a toner image on a sheet;
a first detector for detecting a temperature of one longitudinal end portion of said endless belt;
a second detector for detecting a temperature of the other longitudinal end portion of said endless belt; and
a controller for controlling whether or not notification of generation of an error is provided on the basis of a change amount per unit time of a difference in detection temperature between said first detector and said second detector.

2. An image heating apparatus according to claim 1, wherein, when the change amount per unit time exceeds a predetermined value, said controller provides the notification of the generation of the error.

3. An image heating apparatus according to claim 2, wherein, when the change amount per unit time is not more than the predetermined value, said controller does not provide the notification of the generation of the error.

4. An image heating apparatus according to claim 1, wherein, when the change amount per unit time exceeds a predetermined value, said controller not only provides the notification of the generation of the error but also prohibits execution of an image heating process.

5. An image heating apparatus according to claim 4, wherein, when the change amount per unit time is not more than the predetermined value, said controller does not provide the notification of the generation of the error and permits the execution of the image heating process.

6. An image heating apparatus according to claim 1, wherein, when the change amount per unit time exceeds a predetermined value during execution of an image heating process, said controller not only provides the notification of the generation of the error but also interrupts execution of an image heating process.

7. An image heating apparatus according to claim 6, wherein, when the change amount per unit time is not more than the predetermined value during execution of the image heating process, said controller does not provide the notification of the generation of the error and continuous the execution of the image heating process.

8. An image heating apparatus according to claim 2, comprising a plate-shaped heater, elongating in a longitudinal direction of said endless belt, for heating said endless belt,
wherein said first detector and said second detector are provided on said heater.

9. An image forming apparatus according to claim 1, wherein said error is breakage of said endless belt.

10. An image heating apparatus according to claim 1, further comprising a rotatable member, which is a rotatable member for nipping and feeding the sheet between itself and said endless belt, for rotationally driving said endless belt.

11. An image heating apparatus according to claim 10, further comprising;
a first preventing portion, provided so as to be capable of being abutted against one longitudinal end of said endless belt, for preventing movement of said endless belt from the other longitudinal end of said endless belt toward said one longitudinal end, and
a second preventing portion, provided so as to be capable of being abutted against said the other longitudinal end of said endless belt, for preventing movement of said endless belt from said one longitudinal end toward said the other longitudinal end.
